(19) United States
(12) Patent Application Publication
(10) Pub. No.: US 2014/0165631 A1
(43) Pub. Date: Jun. 19, 2014

(54) Refrigeration Compositions, Refrigeration Systems and Methods of Making, Operating and Using the Same

(71) Applicant: GM GLOBAL TECHNOLOGY OPERATIONS LLC, Detroit, MI (US)

(72) Inventors: Jeffrey Santrock, Grosse Pointe Farms, MI (US); Todd J. Gordon, Royal Oak, MI (US); Jeffrey A. Bozeman, Rochester, MI (US); Bryan M. Styles, South Lyon, MI (US)

(73) Assignee: GM Global Technology Operations LLC, Detroit, MI (US)

(21) Appl. No.: 13/715,353

(22) Filed: Dec. 14, 2012

(51) Int. Cl. C09K 5/04

(52) U.S. Cl. CPC C09K 5/045
USPC 62/84; 62/468; 252/68

(57) ABSTRACT

One variation may include a product including a mixture including CF3CF═CH2 and a lubricating oil or grease wherein the lubricating oil or grease that reduces eliminates the likelihood that the refrigerant will ignite.

### TECHNICAL FIELD

The field to which the disclosure generally relates to includes refrigeration compositions, refrigeration systems and methods of making, operating and using the same.

### BACKGROUND

Refrigeration compositions and refrigeration systems may be utilized in a variety of applications including, but not limited to, vehicles.

### SUMMARY OF ILLUSTRATIVE VARIATIONS OF THE INVENTION

One variation may include a product including a vehicle having an engine compartment, a combustion engine and exhaust gas system connected to the combustion engine constructed and arranged to discharge exhaust gas therefrom, wherein the combustion engine and at least a portion of the exhaust gas system are in the engine compartment; a refrigeration system in the engine compartment positioned such that venting of the refrigerant may result in the refrigerant coming in contact with components of the exhaust gas system when such components are at high temperatures, and wherein the refrigeration system includes a refrigerant including CF3CF═CH2, and refrigeration system a lubricating oil or grease wherein the lubricating oil or grease that reduces the already low likelihood (or probability) that the refrigerant and lubricating oil or grease will ignite.

One variation may include a product including a mixture comprising including CF3CF═CH2 and a lubricating oil or grease wherein the lubricating oil or grease that reduces or eliminates the already low likelihood (or probability) that the refrigerant and lubricating oil will ignite.

One variation may include a refrigerant including CF₃CF═CH₂ and a lubricating or grease including a fluorinated component.

One variation may include a method including providing a vehicle having an engine compartment, a combustion engine and exhaust gas system connected to the combustion engine constructed and arranged to discharge exhaust gas therefrom, wherein the combustion engine and at least a portion of the exhaust gas system are in the engine compartment; a refrigeration system in the engine compartment positioned such that venting of the refrigerant may result in the refrigerant coming in contact with components of the exhaust gas system when such components are at high temperatures, and wherein the refrigeration system includes a refrigerant including CF3CF═CH2 and the refrigerant carrying a lubricating oil or grease wherein the lubricating oil or grease that reduces or eliminates the already low likelihood (or probability) that the refrigerant and lubricating oil will ignite; venting the refrigerant carrying the lubricating oil or grease that reduces or eliminates the already low likelihood (or probability) that the refrigerant and lubricating oil will ignite, and wherein the refrigerant carrying the lubricating oil or grease that reduces or eliminates the already low likelihood (or probability) that the refrigerant will ignite comes in contact with the exhaust system at a high temperature without the refrigerant or the lubrication oil or grease igniting.

Other illustrative variations of the invention will become apparent from the detailed description provided hereinafter. It should be understood that the detailed description and specific examples, while disclosing optional variations of the invention, are intended for purposes of illustration only and are not intended to limit the scope of the invention.

### BRIEF DESCRIPTION OF THE DRAWINGS

Select examples of variations of the invention will become more fully understood from the detailed description and the accompanying drawings, wherein:

FIG. 1 is a schematic illustration of a refrigeration cycle which may be utilized in a number of variations of the invention.

FIG. 2 is a schematic illustration of a vehicle, with portion removed, including a refrigeration system illustrating a number of variations of the invention.

### DETAILED DESCRIPTION OF ILLUSTRATIVE VARIATIONS OF THE INVENTION

The following description of the embodiment(s) is merely illustrative in nature and is in no way intended to limit the invention, its application, or uses.

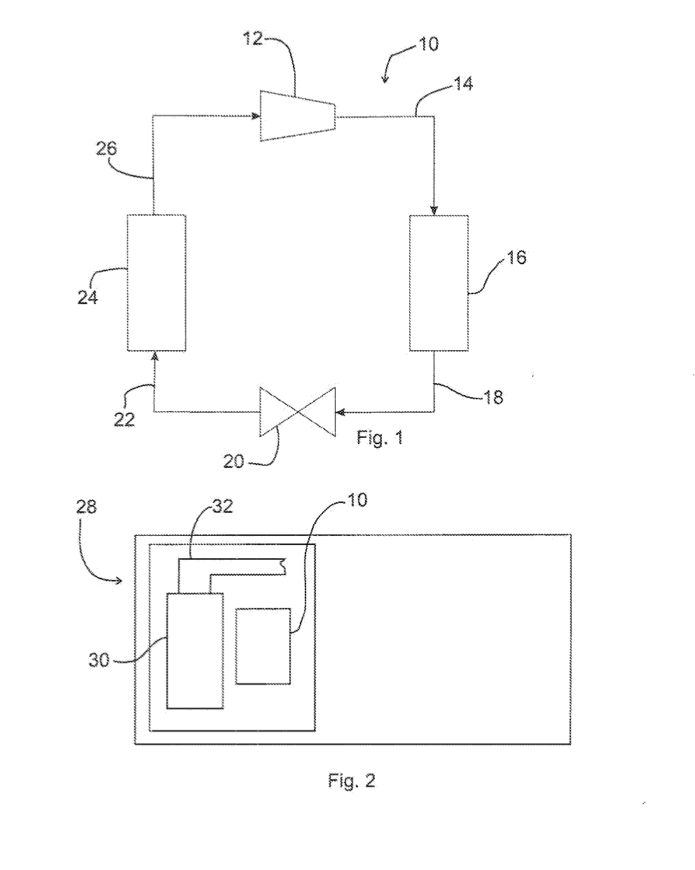

Refrigeration systems may have a variety of configurations useful according to a number of variations of the invention. FIG. 1 illustrates one variation which may include a refrigeration system including refrigerant that undergoes a refrigeration cycle or Rankin cycle. The refrigerant may travel through a compressor 12 which increases the pressure of the refrigerant. The refrigerant exits the compressor 12 typically in a vapor phase and travels through line 14 to a condenser 16 which condenses some or all of the vapor to a liquid phase. The refrigerant travels through line 18 to an expansion valve 20 that reduces the pressure of the refrigerant causing at least a portion of the refrigerant to change from vapor to a liquid phase. The refrigerant in both liquid and vapor phase travels though line 22 to an evaporator 24 causing refrigerant to change to a vapor phase. The refrigerant in a vapor phase travels through line 26 back to the compressor 12. However, the invention is not limited to the variation shown in FIG. 1. Variations of the invention may include a refrigeration cycle or Rankin cycle known now or in the future to those skilled in the art.

A variety of the components in the refrigeration cycle require a lubricant to operate properly. For example, a lubricating oil or grease may be added to lubricate the compressor 12. The lubricating oil er grease may be applied directly to the components of the compressor 12 and/or a lubricating oil may be added to the refrigerant. Even if a lubricating oil or grease is applied only to the components of the compressor, the lubricating oil or grease may be miscible in the refrigerant or otherwise be combined or carried by the refrigerant and travel through the refrigeration system. There may be a number of events which either intentionally or unintentionally causes the refrigerant and lubricating oil to be vented to the atmosphere, in certain circumstances, some refrigerants or a refrigerant including a lubricating oil or grease may be combined with oxygen at high temperatures resulting in ignition.

One variation may include a refrigerant including CF₃CF═CH₂ in a refrigeration system including a lubricating or grease including a fluorinated component. The refrigerant may include 2,3,3,3-tetrafluoroprop-1-ene [754-12-1]. A suitable refrigerants including CF₃CF═CH₂ is commonly known as R1234yf or HFO1234yf and are available from Honeywell and DuPont.

In one variation the refrigeration system may include a fluorinated lubricating oil or grease. In another variation the refrigeration system may include a lubricating oil or grease and a fluorinated compound, a polymer including a fluorinated unit, or a molecule including a fluorinated group. In another variation, a composition including a refrigerant including CF₃CF═CH₂ may be combined with a lubricating oil or grease, and a fluorinated compound, a polymer including a fluorinated unit, or a molecule including a fluorinated group. The lubricating oil or grease may be miscible in the refrigerant or may be combined with or carried with the refrigerant in the refrigeration system.

One variation may include a composition including a refrigerant including CF₃CF═CH₂ and a lubricating oil or grease wherein the lubricating oil or grease reduces or eliminates the already low likelihood (or probability) that the refrigerant will ignite. For example, under certain circumstances the refrigerant including CF₃CF═CH₂ by itself may be combined with oxygen at a first temperature to ignite. A lubricating oil or grease which may be combined with oxygen at a second temperature, which is greater than the first temperature, may also ignite. When the refrigerant including CF₃CF═CH₂, which ignites at the first temperature, is combined with the lubricating oil or grease, which ignites at the second temperature, the resultant mixture may ignite at a third temperature greater than the first temperature.

Another variation of the invention includes a composition including a refrigerant including CF₃CF═CH₂ and a lubricating oil or grease wherein the lubricating oil or grease does not ignite. The refrigerant including CF₃CF═CH₂ by itself may be combined with oxygen at a first temperature to ignite. When the refrigerant including CF₃CF═CH₂, which may ignite at the first temperature is combined with the lubricating oil or grease that does ignite, the mixture may ignite at a second temperature higher than the first temperature or the mixture may not ignite.

in one variation the lubricating oil may be any of a number of variations of low molecular weight fluorine homopolymers of hexafluoride propylene epoxide. In one variation the lubricating of may include a molecule having the following chemical structure:

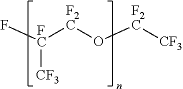

or (F—(CF (CF₃)—CF₂—O)ₙ—CF₂CF₃). The polymer chain may be completely saturated and contains only elements carbon, oxygen and fluorine. There is no hydrogen present. On a weight basis, the oil subunite may contain 21.7% carbon, 9.6% oxygen and 68.7% fluorine. A lubricating grease may be utilized including a base oil, such as but not limited to PFPE, and polytetrafluoroethylene powder having the following chemical structure:

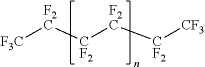

or (CF₃—CF₂—(CF₂—CF₂)ₙ—CF₂—CF₃).

In another variation, polytetrafluoroethylene powder or other fluorinated compound may be combined with an oil such as, but not limited to, PAG (polyalkylene glycol) oil or POE (polyester) oil.

in one variation, the lubricating oil may include PAG (polyalkylene glycol) oil or POE (polyester) oil and a fluorinated compound, a polymer including a fluorinated unit, or a molecule including a fluorinated group.

In the operation of the refrigeration system a mixture of the refrigerant including CF₃CF═CH₂ and a lubricating oil or grease including a fluorinated compound, a polymer including a fluorinated unit, or a molecule including a fluorinated group may be vented to the atmosphere under a variety of conditions including, but not limited to, repair of the refrigeration system components, recharging the refrigeration system with the refrigerant, permeation of the refrigerant mixture through refrigeration components such as hose lines or seals, leaking refrigeration components, puncture of refrigeration components or through a vehicle crash in which components of the refrigeration system may be damaged. The mixture of the refrigerant and the lubricating oil or grease including a fluorinated compound, a polymer including a fluorinated unit, or a molecule including a fluorinated group may come in contact with high temperature components of the vehicle such as the combustion engine exhaust system. The mixture of the refrigerant in the lubricating oil or grease may under certain circumstances collect under heat shields over portions of the combustion exhaust system where movement or dissipation of the vapors may be reduced thereby increasing the already low chance of ignition. However, the inclusion of a lubricating oil or grease including a fluorinated corn pound, a polymer including a fluorinated unit, or a molecule including a fluorinated group reduces the likelihood or eliminates the already low (likelihood or probability) of ignition.

Another variation may include a vehicle having an engine compartment including a combustion engine and exhaust gas system connected to the combustion engine constructed and arranged to discharge exhaust gas therefrom. The vehicle may also include a refrigeration system in the engine compartment and wherein the refrigeration system includes a refrigerant including CF₃CF═CH₂ and a lubricating oil or grease, wherein the lubricating oil or grease reduces or eliminates the already low likelihood that the refrigerant will ignite as described herein. The refrigeration system may be positioned such that venting of the refrigerant may result in the refrigerant coming in contact with components of the exhaust gas system such as an exhaust manifold, turbocharger, or other exhaust system component and a like when such components are at high temperatures.

FIG. 2 is an illustration of a vehicle 28 including a combustion engine 30 with a connected exhaust system 32 and a refrigeration system 10 illustrating a number of variations of the invention.

Suitable lubricating oils and grease for numerous variations of the invention are available from DuPont under the tradename KRYTOX.

The above description of select examples of embodiments of the invention is merely exemplary in nature and, thus, variations or variants thereof are not to be regarded as a departure from the spirit and scope of the invention.

What is claimed is:

1. A product comprising:
a vehicle having an engine compartment, a combustion engine and exhaust gas system connected to the combustion engine constructed and arranged to discharge exhaust gas therefrom, wherein the combustion engine and at least a portion of the exhaust gas system are in the engine compartment;
a refrigeration system in the engine compartment positioned such that venting of the refrigerant may result in the refrigerant coming in contact with components of the exhaust gas system and a like when such components are at high temperatures, and wherein the refrigeration system includes a refrigerant including CF3CF═CH2, the refrigeration system including a lubricating oil or grease wherein the lubricating oil or grease that at least reduces the already low likelihood that the refrigerant will ignite.

2. A product as set forth in claim 1 wherein the lubricating oil or grease comprises a fluorinated compound, a polymer including a fluorinated unit, or a molecule including a fluorinated group.

3. A product as set forth in claim 1 wherein the lubricating oil or grease is a fluorinated lubricating oil.

4. A product as set forth in claim 3 wherein the fluorinated lubricating oil comprises low molecular weight fluorine homopolymer of hexafluoride propylene epoxide.

5. A product as set forth in claim 1 wherein the fluorinated lubricating oil includes a polymer having the chemical structure: 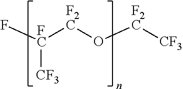
where n=10-60.

6. A product as set forth in claim 3 wherein the lubricating oil or grease comprises a fluorinated grease.

7. A product as set forth in claim 3 wherein the grease comprises a base oil and polytetrafluoroethylene powder having the following chemical structure:

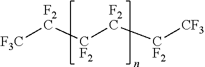

8. A product as set forth in claim 7 wherein the base oil comprises a perfluoropolyether.

9. A product as set forth in claim 2 wherein the lubricating oil or grease comprises a lubricating oil comprising PAG oil or POE oil.

10. A product as set forth in claim 1 wherein the refrigeration system includes a compressor and wherein the lubricating oil or grease is applied to components in the compressor.

11. A product as set forth in claim 1 wherein the refrigerant includes a mixture of the CF3CF═CH2, and the lubricating oil or grease that at least reduces the likelihood that the refrigerant will undergo a undesirable exothermic event.

12. A product comprising:
a mixture comprising including CF3CF═CH2 and a lubricating oil or grease, wherein the lubricating oil or grease that reduces or eliminates the likelihood that the refrigerant will ignite.

13. A product as set forth in claim 12 wherein the lubricating oil or grease comprises a fluorinated compound, a polymer including a fluorinated unit, or a molecule including a fluorinated group.

14. A product as set forth in claim 12 wherein the lubricating oil or grease is a fluorinated lubricating oil.

15. A product as set forth in claim 14 wherein the fluorinated lubricating oil comprises low molecular weight fluorine homopolymer of hexafluoride propylene epoxide.

16. A product as set forth in claim 12 wherein the fluorinated lubricating oil includes a polymer having the chemical structure: 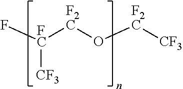
where n=10-60.

17. A product as set forth in claim 12 wherein the lubricating oil or grease comprises a fluorinated grease.

18. A product as set forth in claim 17 wherein the grease comprises a base oil and polytetrafluoroethylene powder having the following chemical structure:

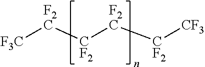

19. A product as set forth in claim 7 wherein the base oil comprises a perfluoropolyether.

20. A product comprising a refrigerant including CF3CF═CH2 and a lubricating or grease including a fluorinated component.

21. A method comprising:
providing a vehicle having an engine compartment, a combustion engine and exhaust gas system connected to the combustion engine constructed and arranged to discharge exhaust gas therefrom, wherein the combustion engine and at least a portion of the exhaust gas system are in the engine compartment;
a refrigeration system in the engine compartment positioned such that venting of the refrigerant may result in the refrigerant coming in contact with components of the exhaust gas system such as a manifold and a like when such components are at high temperatures, and wherein the refrigeration system includes a refrigerant including CF3CF═CH2 and the refrigerant carrying a lubricating oil or grease, wherein the lubricating oil or grease that reduces eliminates the likelihood that the refrigerant will ignite;
venting the refrigerant carrying the lubricating oil or grease that reduces or eliminates the likelihood that the refrigerant will ignite, and wherein the refrigerant carrying the lubricating of or grease that reduces or eliminates the likelihood that the refrigerant will ignite comes in contact with the exhaust system at a high temperature without the refrigerant or the lubrication oil or grease igniting.
